(19) United States
(12) Patent Application Publication
(10) Pub. No.: US 2008/0101187 A1
(43) Pub. Date: May 1, 2008

(54) Optical disc recording apparatus

(75) Inventors: Norihide Kohmoto, Kawasaki (JP); Takashi Arata, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/893,906

(22) Filed: Aug. 17, 2007

(30) Foreign Application Priority Data
Oct. 30, 2006 (JP) 2006-293477

(51) Int. Cl. G11B 5/58

(52) U.S. Cl. 369/53.17

(57) ABSTRACT

An optical disc apparatus including a buffer controller managing a buffer memory, a disc state manager managing and searching for recordable/unrecordable states on a disc, a defect detector detecting defective sectors on the disc, and an optical disc drive device that can record even on the defective sectors. When a defective sector region i.e. a set of defective sectors exists in a wide range, file management information is recorded. If the range is narrow, recording is continued by recording dummy data on the defective sector region and resuming to record regular data upon arrival of normal sectors. The range of the defective sector region is defined as wide when the buffer memory would be exhausted on the way if the dummy data recording was continued, whereas it is defined as narrow when the buffer memory would not be exhausted.

### INCORPORATION BY REFERENCE

The present application claims priority from Japanese application JP2006-293477 filed on Oct. 30, 2006, the content of which is hereby incorporated by reference into this application.

### BACKGROUND OF THE INVENTION

The present invention relates to an optical disc recording apparatus for recording data on a write-once optical disc medium. In particular, the present invention relates to a technique for coping with occurrence of a recording error.

When data should be recorded onto a write-once optical disc medium in an optical disc recording apparatus in conformity to the VR (Video Recording) standards, writing is performed in accordance with the UDF (Universal Disk Format) file system. If a write error occurs during this recording, recording is stopped when the error has occurred. When recording is finished, therefore, file management information (VAT ICB) and management information (VAT) to be recorded cannot be recorded and a file system is not recorded completely. As a result, it becomes impossible to read out all recorded data and data disappear, in some cases.

In view of such a situation, the following techniques have been proposed until now.

In JP-A-2005-346899, a technique concerning data restoration conducted when data recording has failed is disclosed.

When a defect of a disc is detected during data recording, dummy data is recorded in a place of a recording error and thereafter regular data is recorded. A technique concerning this operation is disclosed in JP-A-9-270175.

### SUMMARY OF THE INVENTION

In the conventional technique as disclosed in JP-A-2005-346899, however, data are restored after recording is finished. Therefore, it is necessary to retain all of recording source data and use them as restoration data. In the case of real time recording of a broadcast wave or move recording of a copyright protected program, therefore, an enormous buffer memory for storing all of the recording source data is necessary. This causes a problem that the conventional technique cannot be applied to the optical disc apparatus having a limited buffer memory capacity.

In the conventional technique as disclosed in JP-A-9-270175, buffer memory management during dummy data recording is not considered. If, in real time recording, the range of defective sectors is large and it is necessary to record dummy data over a long time, therefore, the data quantity of recording source data to be stored in a buffer memory exceeds the capacity of the buffer memory and overflow is caused, resulting in a problem of disappearance of the recording source data and occurrence of noise.

An object of the present invention is to solve the problems and prevent disappearance of all file data.

In order to solve the problems, the present invention provides an optical disc recording apparatus including defect detection means for detecting defective sectors on a disc, a buffer memory for temporarily storing data to be written onto the disc, and recording control means for judging a range of the defective sectors, wherein when conducting data write processing onto a write-once optical disc, the defect detection means detects defective sectors, while data to be written onto the disc are being temporarily stored in the buffer memory, and when defective sectors are detected, a decision is made by comparing a time period representing a range of the defective sectors judged by the recording control means with a time period over which data can be recorded into the buffer memory, and recording is continued or stopped based on the decision. As a result, it is possible to select whether to execute recording processing with the defective sectors avoided or whether to execute recording stop processing with all file data prevented from disappearing.

If recording is stopped in the optical disc recording apparatus, then file management information (VAT ICB) and management information (VAT) are recorded on this side of the defective sectors detected by the defect detection means and recording processing is stopped, and if recording is continued, dummy data is recorded on the defective sectors and data temporarily stored in the buffer memory are recorded beginning with a recordable area subsequent to the defective sectors.

If the defective sectors extend over a wide range, the file management information (VAT ICB) and the management information (VAT) are thus recorded on this side of the defective sectors and then the recording is stopped. Therefore, disappearance of data caused by loss of the management information can be prevented. If the range of the defective sectors is small, dummy data is recorded on the defective sectors and then recording source data are recorded. Therefore, it is possible to maintain the continuity of data and prevent noise from being generated by data loss.

According to the present invention, it is possible to provide an optical disc recording apparatus that allows continuous use of a disc even if defective sectors are present and prevents disappearance of data, and that can be used conveniently by the user.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a schematic configuration example of a recording and reproducing apparatus according to the present invention;

FIG. 2 is a diagram showing an example of a recording data layout in a digital recording and reproducing apparatus according to the present invention;

FIG. 3A is a diagram showing a flow chart in the case where real time recording is executed in a recording and reproducing apparatus according to the present invention;

FIG. 3B is a diagram showing a flow chart in the case where real time recording is executed in a recording and reproducing apparatus according to the present invention;

FIG. 4 is a diagram showing relations between defective sectors and buffer memory management in a recording and reproducing apparatus according to the present invention;

FIGS. 5A and 5B are diagrams showing relations between disc state management and recording in a recording and reproducing apparatus according to the present invention; and

FIG. 6 is a diagram showing management of a file that strides over a defective sector region in a recording and reproducing apparatus according to the present invention.

### DESCRIPTION OF THE EMBODIMENTS

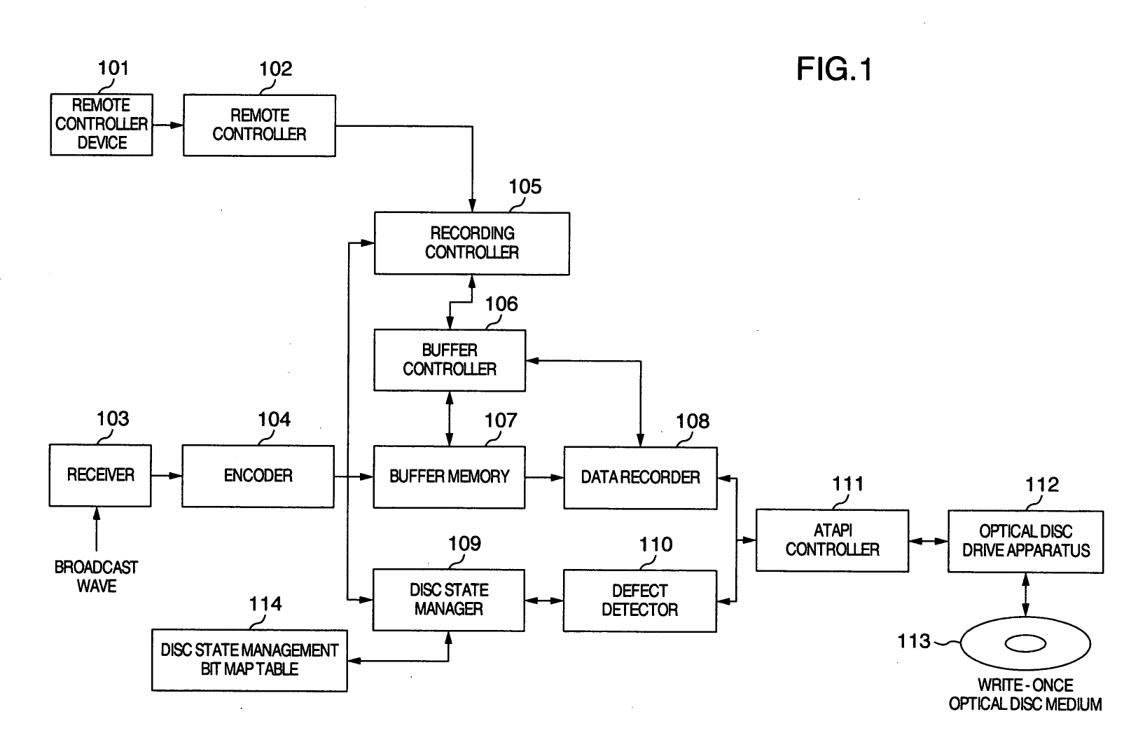

First, an outline of an embodiment of the present invention will now be described. An example of an embodiment according to the present invention is shown in FIG. 1. In FIG. 1, an optical disc recording apparatus includes a remote controller device 101 which can be operated by a user, a remote controller 102 for receiving a signal from the remote controller device 101 and giving a notice concerning contents of the signal, a receiver 103 for receiving a broadcast of a selected program, an encoder 104 for encoding a video signal of the received program, a buffer memory 107 for temporarily storing encoded program data, a buffer controller 106 for notifying a recording controller 105 that the data in the buffer memory has reached a threshold of an upper limit or a lower limit previously set, a data recorder 108 for recording the program data in a form conforming to the UDF (Universal Disk Format) standards and recording dummy data on defective sectors, a defect detector 110 for previously detecting defective sectors on a disc, a disc state manager 109 for managing defect states of the disc such as a result detected by the defect detector 110 and retaining of detected positions, and a disc state management bit map table 114. The optical disc recording apparatus starts and finishes recording in response to a command given by the remote controller device.

The optical disc recording apparatus further includes a recording controller 105 for referring to the disc state management bit map table 114, conducting normal recording when there are no defective sectors, and discriminating a range of defective sectors when there are defective sectors, an ATAPI controller 111 for controlling an optical disc drive device 112 according to ATA/ATAPI standards, and the optical disc drive device 112 which analyzes a command issued on the basis of the ATA/ATAPI standards, and performs writing, reading or the like on a write-once optical disc medium 113, and which can perform writing even on defective sectors although reading is not ensured.

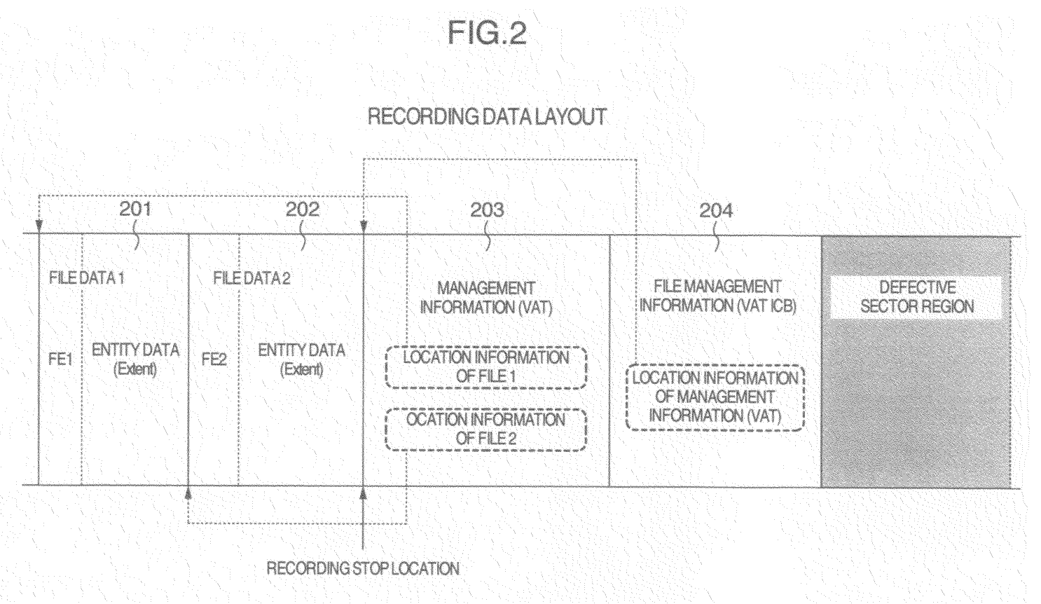

FIG. 2 is a diagram showing an example of a data layout at the time of data writing on the write-once optical disc medium 113. Writing using an incremental write scheme in the UDF file system is shown. The layout includes file data 201 and 202 each including a set of entity data (extent) of each file and management information (FE) having location information of the set, management information (VAT) 203 for virtually managing location information of files, and file management information (VAT ICB) 204 having location information of the management information (VAT) 203.

At the time of data reading, desired data can be read out by referring to the management information (VAT) 203 on the basis of location information described in the file management information (VAT ICB) 204, acquiring location information of the desired file, and accessing the file.

At the time of data writing, file data is written and then new registration or update registration of location information of the file in the management information (VAT) 203 is conducted and the location information is written at end of disc recording as the file management information (VAT ICB) 204. (It is defined in the UDF standards.)

If reading or writing of the management information (VAT) 203 or the file management information (VAT ICB) 204 fails, location information of all files becomes indistinct. Therefore, the file data look as if they have disappeared.

One of causes of such a situation is occurrence of a recording error resulting from influence of defective sectors caused on the write-once optical disc medium 113 by a fingerprint or flaw. If a recording error has occurred, subsequent writing becomes impossible and consequently it becomes impossible to write the file management information (VAT ICB) 204 into the recording end on the disc.

Even if a defective sector region generated by the above-described cause is present while real time recording is being conducted on the write-once optical disc medium 113, disappearance of file data is prevented in the present embodiment by stopping the recording on this side of the defective sector region and writing the file management information (VAT ICB) 204 according to the region range. Or the real time recording is continued by recording and managing regular file data except the defective sector region. (In this case, dummy data is written into the defective sector region.)

Here, the defective sector region is defined as follows. For conducting writing or reading on the write-once optical disc medium 113, the ATAPI controller 111 issues a write or read command which belongs to the ATAPI command group defined in SFF 8090 standards to the optical disc drive device 112. On the basis of the write or read command, specified data is written or read. If an execution result of the command at this time is a command error resulting from defective sectors, the region is regarded as a defective sector region. A method for detecting a defective sector region will be described later.

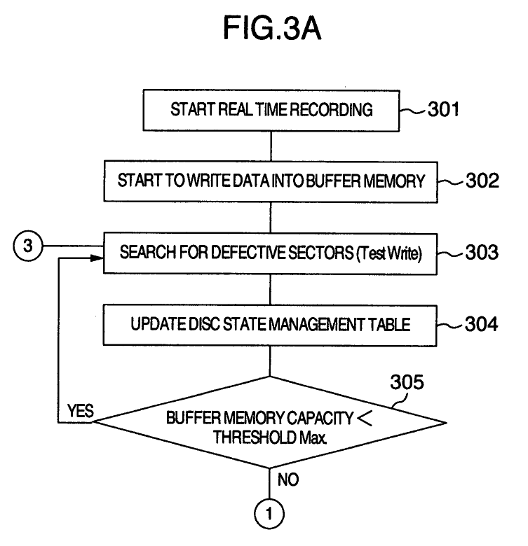

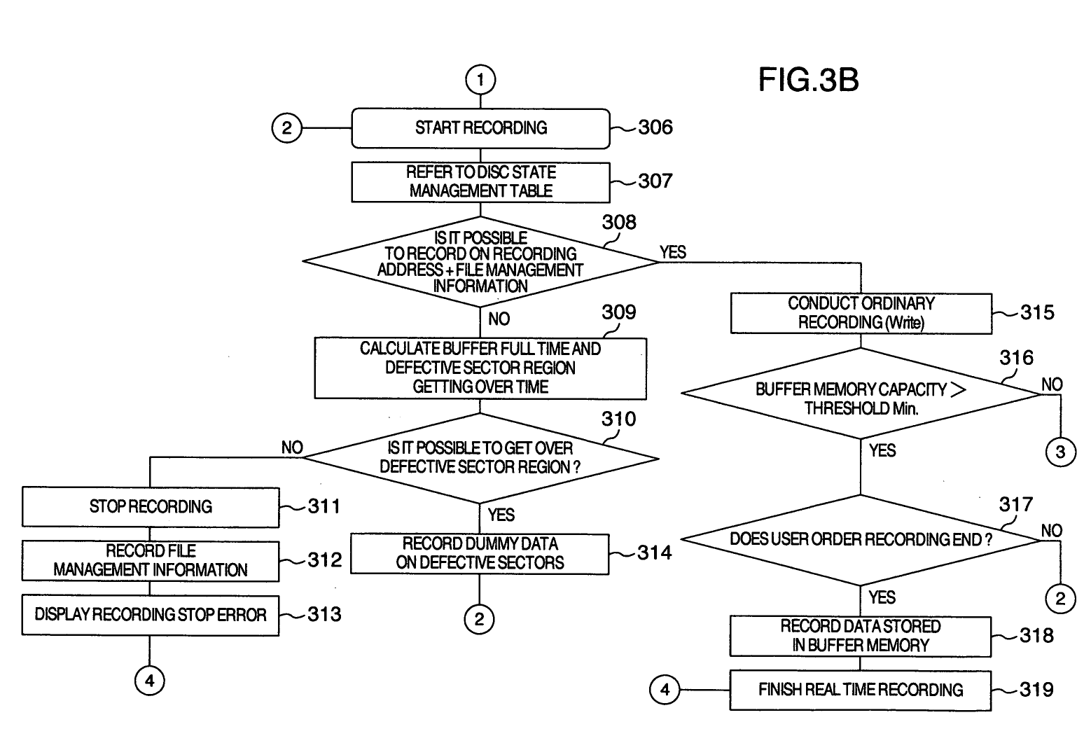

FIGS. 3A and 3B are diagrams showing a flow chart corresponding to the case where a recording error has occurred during real time recording, as a general processing method in the present embodiment. Its process will now be described with reference to FIGS. 3A and 3B.

First, the user presses a recording start key on the remote controller device. The remote controller 102 gives a notice to the recording controller 105 to start real time recording (301). As a result, the recording controller 105 gives a notice of recording start to the buffer controller 106. Accordingly, writing program data encoded by the encoder 104 into the buffer memory 107 is started (302). While the program data is being written into the buffer memory 107, the defect detector 110 searches for defective sectors on the disc (303).

A method for searching for defective sectors will be described later. On the basis of the result of the defective sector detection conducted by the defect detector 110, the disc state manager 109 updates the disc state management bit map table 114 by setting the disc state to a normal sector or a defective sector (304). The disc state management bit map table 114 is a table for conducting state management on the whole disc by using bits respectively corresponding to the sectors to indicate whether there are defective sectors on the recording disc. A completion location of search for defective sectors is also retained in the disc state manager 109. The processing 303 of searching for defective sectors is repeated until the volume in the buffer memory 107 exceeds a previously set threshold Max. (305).

If the volume in the buffer memory 107 exceeds the “threshold Max.” in 305, then the recoding controller 105 causes the buffer controller 106 to give a notice to the data recorder 108 to start actual writing onto the disc (306). The disc state manager 109 refers to the disc state management bit map table 114 which reflects the result of the search for defective sectors 303 (307). It is determined whether there isn't a defective sector region in an address advanced from a recording address by a size of file management information recording and whether recording is possible (308). If recording is possible, the buffer controller 106 gives a notice to the data recorder 108 and ordinary recording processing is conducted (315). Recording is continued until the volume in the buffer memory becomes a threshold Min. or less. If the user orders real time recording end 317 (by using a key on the remote controller device or the like), then data in the buffer memory 107 is recorded (318) and real time recording is finished (319).

If in the condition 316 the volume in the buffer memory becomes equal to or less than the threshold Min., then the recording controller 105 causes the defect detector 110 to conduct the search for defective sectors (303) and supplements the buffer memory 107 with data again during the time. If the condition 317 is not satisfied, the ordinary recording processing is conducted again. If there is a defective sector region in the condition 308, then the recording controller 105 calculates buffer full time according to a calculation formula “(buffer memory total capacity−buffer memory stored data)÷recording rate” and calculates time taken to get over a defective sector region by recording dummy data on the defective sector region, according to a calculation formula “defective sector region size÷recording rate” (309). Here, the recording rate means the data transfer rate used when ordinary recording onto an optical disc is performed. If it is found as a result that the buffer full time>the defective sector region getting over time, then the defective sector region is judged to be able to be gotten over (310) and the data recorder 108 records dummy data on a continuous defective sector region (314).

If the condition 310 is not satisfied, then the recording is stopped (311), and the data recorder 108 records the file management information (VAT ICB) (312), displays recording stop error (313), and finishes real time recording (319).

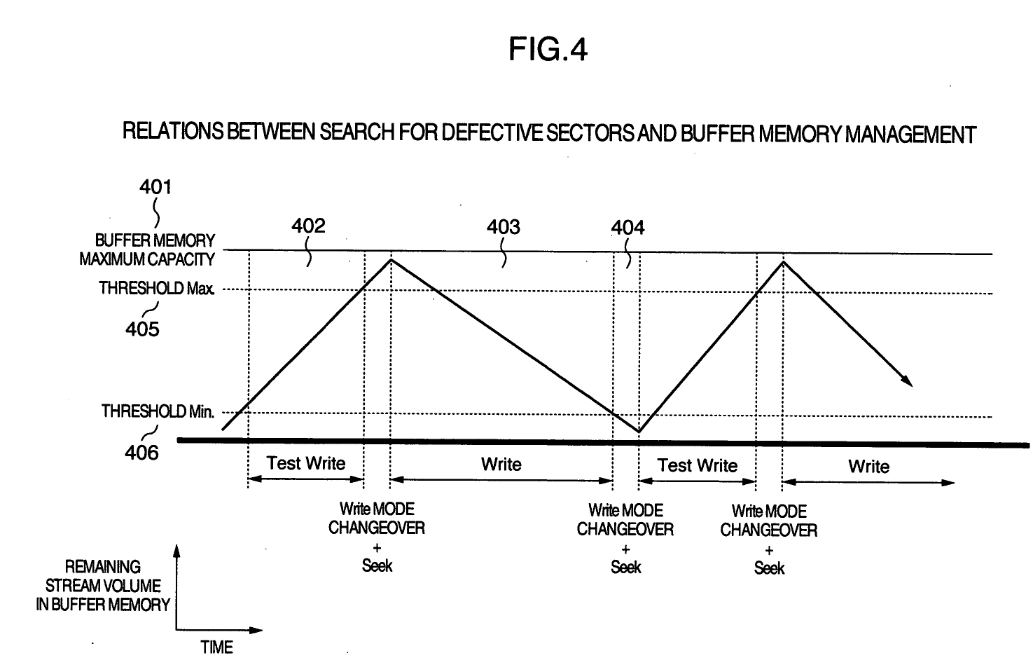

The method for searching for defective sectors on the disc will now be described in detail with reference to FIG. 4. FIG. 4 shows relations between a remaining stream data quantity in the buffer memory and time obtained when the processing method shown in FIGS. 3A and 3B is executed. A buffer memory maximum capacity 401 is a maximum capacity of the buffer memory previously prepared for recording. In the search for defective sectors 303 shown in FIG. 3A, a search for defective sectors is executed by using a time period of test write 402 lasting until the condition 305 where the volume in the buffer memory becomes the threshold Max.

Here, the test write will now be described. In an optical disc recording apparatus corresponding to the test write, “test write” is set in the write parameters mode of the mode sense (10) command which is one command included in an ATAPI command group defined in SFF 8090 standards. As a result, subsequent write commands become the test write mode in which actual recording onto the disc is not conducted. If the test write results in a recording error in the optical disc recording apparatus, that sector is regarded as a defective sector in the present embodiment.

In the ordinary recording 315 shown in FIG. 3B, recording is actually executed by using a time period 403 of “write” until the volume in the buffer memory becomes the threshold Min. in 316. “Write mode changeover+seek” 404 represents time required for mode changeover between “test write” and “write” and seek conducted between a search location for defective sectors and an actual recording location. Write mode changeover timing is determined by a threshold Max. 405 and a threshold Min. 406. In the real time recording, a threshold that does not overrun the buffer memory capacity and a threshold that does not underrun the buffer memory capacity are set.

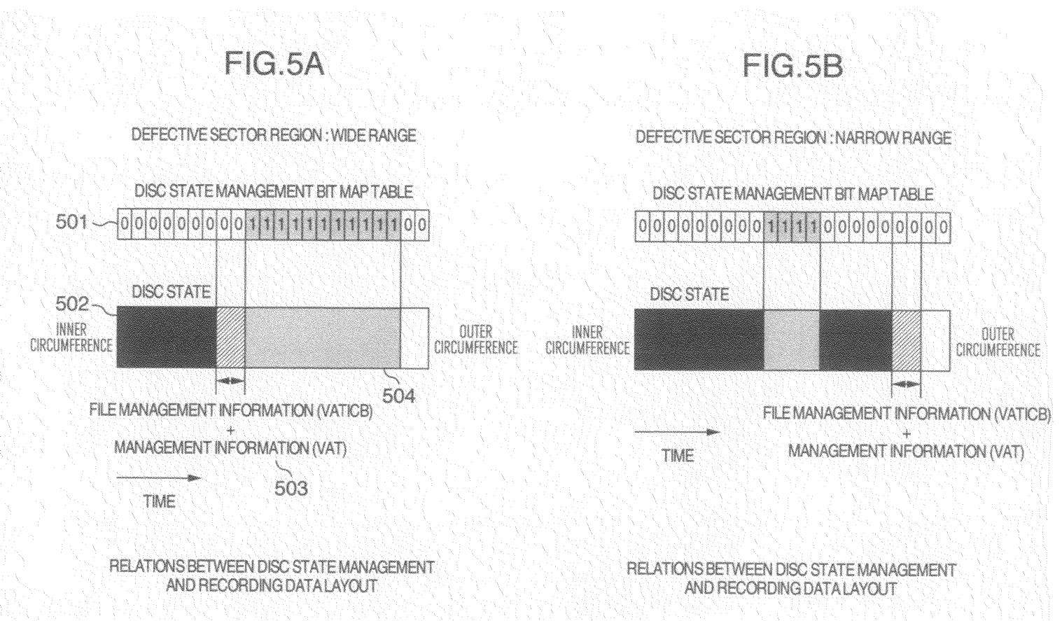

Relations between the disc state management and recording are shown in FIGS. 5A and 5B. A disc state management bit map table 501 for conducting management by setting a bit of a corresponding sector in the bit map table to 1 when a defective sector is found by conducting the search for defective sectors, a disc recorded region 502, a file management information (VAT ICB) and management information (VAT) recording region 503, and a defective sector region 504 are included.

In the disc state management bit map table 501, corresponding sectors are respectively associated with bits beforehand. If a corresponding sector is normal, the bit is set to 0. If a corresponding sector is a defective sector, the bit is set to 1. A range in which the search for defective sectors has been already finished is retained in the disc state manager 109 to determine an effective range in the disc state management bit map table 501.

FIG. 5A shows relations between the disc state management and recording in the case where the defective sector region is wide in range. In the disc state management bit map table, file management information (VAT ICB) and management information (VAT) are recorded on this side of the defective sector region. FIG. 5B shows relations between the disc state management and recording in the case where the defective sector region is narrow in range. Since the medium is a write-once optical disc medium, it is necessary to record on the defective sector region as well. Therefore, the defective sector region is made to be already recorded although reproduction is not ensured, by recording dummy data. After passing through the defective sector region, regular data is recorded again from the normal sector.

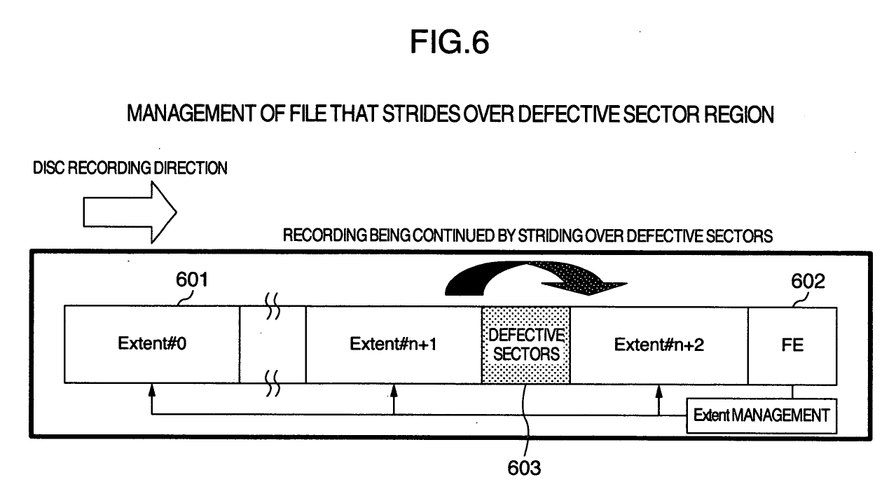

FIG. 6 shows management of a file that strides over a defective sector region. In a UDF file system according to the present embodiment, a set of data recorded consecutively is referred to as extent 601 and one file is formed by using a FE (File Entry) 602 for managing a plurality of extents. As for data management as a file system in the case of FIG. 5B, an extent #n+1 is closed once on this side of the defective sectors, defective sectors 603 are stridden over, and subsequent data is registered in the FE 602 as the next extent #n+2. When playing the disc, therefore, it is not necessary to be conscious of the defective sectors 603.

If in recording onto a write-once optical disc medium according to the present invention a recording error occurs and defective sectors are present, it is determined whether to continue or stop the recording as heretofore described. If the range of the defective sectors is small, it is made possible to continue the real time recording without stopping the recording. In this case, dummy data is recorded on the defective sectors, and regular data is recorded on a normal region. As a result, occurrence of noise caused by recording the regular data onto the defective sectors can be prevented. Furthermore, it is made possible to record regular data on the write-once optical disc after the defective sectors. As a result, continuous use of the disc becomes possible.

If the defective sectors extend over a wide range, then the real time recording is stopped on this side of the defective sectors, and the file management information (VAT ICB) and the management information (VAT) are recorded. As a result, disappearance of all file data can be prevented.

The range of the defective sector region is defined as wide range when the buffer memory would be exhausted on the way if dummy data recording was continued, whereas it is defined as narrow range when the buffer memory would not be exhausted.

It should be further understood by those skilled in the art that although the foregoing description has been made on embodiments of the invention, the invention is not limited thereto and various changes and modifications may be made without departing from the spirit of the invention and the scope of the appended claims.

1. An optical disc recording apparatus comprising:
defect detection means for detecting defective sectors on a disc;
a buffer memory for temporarily storing data to be written onto the disc; and
recording control means for judging a range of the defective sectors;
wherein
when conducting data write processing onto a write-once optical disc, the defect detection means detects defective sectors, while data to be written onto the disc are being temporarily stored in the buffer memory,
when defective sectors are detected, a decision is made by comparing a time period representing a range of the defective sectors judged by the recording control means with a time period over which data can be recorded into the buffer memory, and recording is continued or stopped based on the decision.

2. The optical disc recording apparatus according to claim 1, wherein
if recording is stopped, then file management information (VAT ICB) and management information (VAT) are recorded on this side of the defective sectors detected by the defect detection means and recording processing is stopped, and
if recording is continued, dummy data is recorded on the defective sectors and data temporarily stored in the buffer memory are recorded beginning with a recordable area subsequent to the defective sectors.
